(19) United States
(12) Patent Application Publication
(10) Pub. No.: US 2026/0315953 A1
(43) Pub. Date: Oct. 15, 2026

(54) SOLAR-ASSISTED THERMAL DESALINATION SYSTEM AND ASSOCIATED METHOD

(71) Applicant: RA HEAT PTY LTD, Western Australia (AU)

(72) Inventors: Paul Leslie UNWIN, Queensland (AU); Donald Earl SPENCE, Aksai (KZ)

(73) Assignee: RA HEAT PTY LTD, Western Australia (AU)

(21) Appl. No.: 19/100,981

(22) PCT Filed: Jul. 28, 2023
(86) PCT No.: PCT/EP2023/070998

§ 371 Date: Feb. 4, 2025

(30) Foreign Application Priority Data
Aug. 5, 2022 (GB) 2211423.5

(51) Int. Cl. B01D 1/26; B01D 1/00; B01D 5/00; C02F 1/00; C02F 1/14; C02F 103/08

(52) U.S. Cl. CPC B01D 1/26; B01D 1/0035; B01D 1/0082; B01D 5/0039; B01D 5/006; C02F 1/008; C02F 1/14; C02F 2103/08; C02F 2209/005; C02F 2209/02; C02F 2209/03; C02F 2209/40; C02F 2303/10

(57) ABSTRACT

A solar-assisted thermal desalination system (2) comprising: a thermal desalination plant (4), a flow controller (40), a solar-assisted heat-exchanger array (6) and at least one solar collector (8). The thermal desalination plant (4) has at least one flow-controllable superheated steam inlet and steam discharge port (14, 16). The solar-assisted heat exchanger array has at least first, second and third heat exchanger modules (26, 28, 30), operable in isolation of each other. The solar-assisted heat-exchanger array (6) is in communication with the at least one solar collector (8) for supplying heat energy thereto. Such a solar-assisted thermal desalination system (2) is arranged to superheat steam taken from the thermal desalination plant (4) so as to be suitable for reintroduction back into the thermal desalination plant (4) for retreatment.

The present invention relates to a solar-assisted thermal processing system, and particularly to a solar-assisted thermal desalination system. Furthermore, the present invention relates to a method of improving the thermal processing efficiency of a thermal processing plant, particularly to a thermal desalination plant.

Thermal desalinisation plants are a type of thermal processing plant, whereby salt and brackish water, which make up over 97% of water on earth, can be purified into fresh water suitable for human consumption. Thermal desalination accounts for around half of the desalination market and provides a suitable solution for management of growing water demand in many arid parts of the world, such as parts of the Middle East.

Thermal desalination plants use energy to evaporate feed salt/brackish water, which is then condensed, the condensate being collected as fresh water.

In multieffect distillation desalination plants, feed saltwater is fed into a first effect where it is evaporated on heated pipes. The hot evaporate is then fed through pipes into a tubular bundle or similar in a second effect. Feed or recycled saltwater is then heated and evaporated by the tubular bundle in the second effect. The evaporate from the first effect is then condensed as fresh water to be collected. The evaporate from the second effect is then fed through pipes into a tubular bundle in the third effect, and the process continues in the same way.

This happens over a number of effects arranged in series, each effect operating at a lower temperature and pressure than the last. Once the evaporate leaves the final effect it is then sent to a condenser, or is vented, whereby the latent heat is then lost, not to be used by a next effect.

One way to minimise this loss and increase the production of fresh water could be the inclusion of many more effects. However, this is not a viable solution in terms of material costs, energy requirements which scales with the number of stages or effects, associated maintenance, and other constraints.

It is an object of the present invention to reduce or substantially obviate the aforementioned problem, along with similar problems.

According to the present invention there is provided a solar-assisted thermal desalination system comprising: a thermal desalination plant having at least one flow-controllable superheated steam inlet port and at least one flow-controllable steam discharge port; a solar-assisted heat-exchanger array having at least first, second, and third heat exchanger modules which are operable in isolation of each other; a flow controller for controlling steam flow from the steam discharge port to each of the first, second, and third heat exchanger modules, the flow controller including a determinator element for determining which of the first, second, and third heat exchanger modules receives steam from the steam discharge port based on a reheating schedule whereby a continuous or substantially continuous supply of superheated steam is outputtable to the superheated steam inlet port for retreatment; and at least one solar collector in communication with the first, second, and third heat exchanger modules to supply solar heat energy thereto.

Such a solar-assisted thermal desalination system enables steam to be re-processed by the thermal desalination plant, minimising energy losses. The present invention takes this steam from a steam discharge port, superheats it in the solar-assisted heat-exchanger array using thermal energy collected by the at least one solar collector, and reintroduces it back into the thermal desalination plant, thereby increasing the efficiency of such a plant by re-using otherwise lost energy. At least three such heat exchanger modules, which can operate independently, allow the modules to be in a different state of filling, conditioning and discharging, at any one time, which can allow a more continuous and undisturbed supply of recycled steam back into the plant. In particular, one module can be in the filling state, one can be in the conditioning state, and one can be in the discharge state to provide an improved supply of superheated steam.

Preferably, the system further comprises a fourth heat exchanger module, the determinator element for determining which of the first, second, third, and fourth heat exchanger modules receive steam from the steam discharge port based on the reheating schedule, and the solar collector being in communication with the fourth heat exchanger module.

Optionally, the thermal desalination plant includes a plurality of processing modules arranged in series for sequential heat treatment of the said steam. These modules arranged in series may be stages or effects for multistage or multieffect distillation thermal desalination plants, respectively. Such plants reduce the overall energy demand by spreading the thermal processing over multiple stages or effects which operate at successively reduced temperatures and pressures. The present invention provides an effective solution of taking steam with energy that would otherwise be lost, re-heating and pressurising it so as to be suitable for reintroduction to an upstream stage or effect.

Beneficially, the steam discharge port may be located downstream of a central or substantially central processing module. Additionally, the superheated steam inlet port may be located upstream of the central or substantially central processing module. The greater the number of processing modules the steam is recycled through, the greater the advantage such a solar-assisted thermal desalination system can offer. In one particular example, steam could be taken from a module, stage or effect immediately preceding a final treatment stage, for example, the stage or effect prior to entering a condenser. Once reconditioned or superheated, this steam can then be reintroduced to an early module, stage or effect, preferably the first or second effect.

At least one pump may be included and located between the steam discharge port and the solar-assisted heat-exchanger array. Inclusion of pumps may also be used throughout the system to create the required pressure gradients or overcome the relevant pressure gradient for fluid control. In some cases, the at least one pump may be a vacuum pump.

Advantageously, the flow controller may include: a first inlet valve and a first outlet valve associated with the first heat exchanger module; a second inlet valve and a second outlet valve associated with the second heat exchanger module; and a third inlet valve and a third outlet valve associated with the third heat exchanger module. Providing outlet and inlet valves to each heat exchanger module can allow effective independent control. Preferably, the valves may be controlled by the determinator element which may include or be a programmable logic control (PLC) module, allowing scheduling by the reheating schedule and automation of such a solar-assisted thermal desalination system.

Beneficially, the flow controller may include an at least one sensor for each heat exchanger module. The or each sensor is for determining pressure and/or temperature. Such sensors may be in communication with a controller which may be included as the determinator element or as part of the determinator element. The controller may include an at least one proportional integral derivative (PID) controller. Such an arrangement can identify when the correct working conditions of the said steam have been met so as to be suitable for reintroduction into a thermal desalination plant. The PID controller can then be used to automate this control, preferably by communication with the PLC module of the determinator element. The at least three sensor modules may be or include a pressure and/or temperature sensor. In some cases, the flow controller may include only one, two or more than three sensor modules, one associated with each any one of the at least first, second and third heat exchanger modules and any subsequent heat exchanger modules. Whilst there is described as being a sensor for each heat exchanger module, it will be appreciated that there may be only a single sensor.

In some instances, the or each heat exchanger modules may include at least three separate heat exchangers. This can allow for manufacture of the at least three heat exchangers separately at an external location. The individual heat exchangers can then be transported more conveniently to a desired location of the solar-assisted thermal desalination system. The heat exchanger modules can then be constructed from the at least three heat exchangers on site. Whilst three heat exchangers per module are described, it will be appreciated that only one or more heat exchangers may be considered per module.

In the instance where the determinator element may include or be the PLC module, programmable logic control can be used to execute the reheating schedule and automate, at least in part or wholly, the solar-assisted thermal desalination system.

The solar-assisted heat-exchanger array may at least in part be manufactured from a corrosion resistant material, which may be stainless-steel, such as 304 stainless-steel or 316 stainless-steel. Carbon steel may also be used, which will require a coating or lining. The coating or lining will need to be compliant with applicable drinking water regulations. High temperature plastic or fiberglass piping can also be used. These example materials also provide suitable mechanical properties for allowing steam to be pressurised when superheated.

Optionally, the at least one solar collector could be in fluid communication with the heat exchanger modules. Such fluid communication enables the transfer of thermal energy collected by the at least one solar collector to the heat exchanger modules. However, the at least one solar collector may not always be in fluid communication with the first, second and/or third heat exchanger modules. In other instances, this communication may be electrical in nature, for example if the solar collector is a solar cell and the heat exchanger is replaced at least in part by an electrical heating element.

Furthermore, possible fluid communication between the or each at least one solar collector and the solar-assisted heat-exchanger array would be via a working fluid.

The flow rate of the said working fluid may be controlled by the inclusion of a working-fluid flow controller. The working-fluid flow controller may have a working-fluid determinator element for determining flow rate to each of the first, second and/or third heat exchanger modules. Additionally, the determinator element and the working-fluid determinator element may be in communication with each other or be one and the same.

In one particular instance, independent control of the working fluid flow to each of the at least three heat exchanger modules may be realised by the inclusion of: a first working-fluid input valve associated with the first heat exchanger module; a second working-fluid input valve associated with the second heat exchanger module; and/or a third working-fluid input valve associated with the third heat exchanger module. Each said valve may be controlled by the working-fluid determinator element.

Advantageously, each or the at least one solar collector is or includes an array of solar panels. Use of such an array of solar panels can be used to increase the surface area for absorption of electromagnetic radiation to directly heat the working fluid for thermal heat exchange within the solar-assisted heat-exchanger array. If there is electrical communication between the each or the at least one solar collector and the solar-assisted heat-exchanger array, the each or the at least one solar collector may be or include an array of solar cells.

Beneficially, fluid communication between the thermal desalination plant, the solar-assisted heat-exchanger array and the at least one solar collector may be facilitated by at least one conduit. The at least one conduit may be made from a corrosion resistant material which may be stainless-steel. Stainless-steel conduits afford sufficient corrosion resistance and mechanical properties for accommodating heated pressurised fluid. Additionally, the majority of the said stainless-steel pipes may be thermally insulated to help minimise possible thermal losses. In other instances, when the conduits may be metallic pipes, the pipes may be cathodically protected, providing secondary corrosion protection. The conduits may also be constructed using high temperature plastics, carbon fiber composites or fiberglass.

Whilst the system is described as a desalination system, it will be appreciated that the same principles may apply in non-desalination contexts. For example, the thermal desalination plant may be more generally termed as a thermal processing plant. Thermal processing plants may include absorption chillers and energy generation plants. In either case, steam may be taken from the thermal processing plant to be reheated and pressurised so as to match the working conditions at the point of re-entry and reintroduced via the steam inlet port back into such a thermal processing plant. According to a second aspect of the invention, there is provided a heat-exchanger array for the solar-assisted thermal desalination system, the heat-exchanger array comprising: at least first, second, and third heat exchanger modules which have a desalination-plant inlet for receiving steam from the desalination plant and a desalination-plant outlet for distributing superheated steam to the desalination plant, the modules being operable in isolation of each other; and a flow controller for controlling steam flow from the said thermal desalination plant to each of the first, second, and third heat exchanger modules, the flow controller including a determinator element for determining which of the first, second, and third heat exchanger modules receives steam from the thermal desalination plant based on a reheating schedule whereby a continuous or substantially continuous supply of superheated steam is outputtable to the thermal desalination plant for retreatment.

According to a third aspect of the invention, there is provided a solar-assisted heat-exchanger array for the solar-assisted thermal desalination system, for recycling steam from a thermal desalination plant, the solar-assisted heat-exchanger array comprising: at least first, second, and third heat exchanger modules which are operable in isolation of each other; a flow controller having a desalination-plant inlet port located upstream of the at least first, second, and third heat exchanger modules for controlling steam flow from the said thermal desalination plant to each of the first second, and third heat exchanger modules, the flow controller including a determinator element for determining which of the first, second, and third heat exchanger modules receives steam from the thermal desalination plant based on a reheating schedule, the flow controller having a desalination-plant outlet port located downstream of the at least first, second, and third heat exchanger modules, whereby a continuous or substantially continuous supply of superheated steam is outputtable to the thermal desalination plant for retreatment; and at least one solar collector in communication with the first and second heat exchanger modules to supply solar heat energy thereto. Such a solar-assisted heat-exchanger array can be retrospectively installed (retrofitted) to an existing thermal desalination plant or more generally a thermal processing plant.

According to a fourth aspect of the invention, there is provided a method of improving thermal processing efficiency of a thermal desalination plant, using a solar-assisted thermal desalination system, preferably in accordance with the first, second and/or third aspect of the invention, the method comprising the steps of: a] outputting excess steam from a thermal desalination plant to a solar-assisted heat-exchanger array; and b] controlling the solar-assisted heat-exchanger array so that at least first, second and/or third heat-exchanger modules: i] are filled with said excess steam; ii] the said excess steam is superheated at least in part by solar energy; and iii] the superheated excess fluid is discharged to a superheated steam inlet port of the thermal processing plant for retreatment; wherein, the first heat-exchanger module is controlled to undertake sub-steps i], ii], iii], while the second heat-exchanger module is controlled to undertake sub-steps ii], iii], i], and while the third heat-exchanger module is controlled to undertake sub-steps iii], i], ii]. As such, for example, the first heat-exchanger module undertakes sub-step i] at the same time as the second heat-exchanger module undertakes sub-step ii] at the same time as the third heat-exchanger module undertakes sub-step iii].

Such a method can increase the efficiency of a thermal desalination plant by recycling steam back into the said plant for further processing. The inclusion of at least three heat-exchanger modules which, at any one time, may be in a different state of either filling, reheating or discharging can ensure an uninterrupted flow of superheated steam to be re-introduced back into the thermal desalination plant. The method also uses solar energy, a sustainable energy source to reheat the fluid.

Additionally, the method may also include a step to de-pressurise the at least first, second and third heat exchanger modules, so as to match the working conditions at the point of reintroduction into a thermal desalination plant.

According to a fifth aspect of the invention, there is provided a solar-assisted thermal processing system comprising: a thermal processing plant having at least one flow-controllable superheated steam inlet port and at least one flow-controllable steam discharge port; a solar-assisted heat-exchanger array having at least first, second, and third heat exchanger modules which are operable in isolation of each other; a flow controller for controlling fluid flow from the steam discharge port to each of the first, second, and third heat exchanger modules, the flow controller including a determinator element for determining which of the first and second heat exchanger modules receives fluid from the steam discharge port based on a reheating schedule whereby a continuous or substantially continuous supply of superheated steam is outputtable to the superheated steam inlet port for retreatment; and at least one solar collector in communication with the first, second, and third heat exchangers to supply solar heat energy thereto.

For a better understanding of the present invention, and to show more clearly how it may be carried into effect, reference will now be made by way of example only to the accompanying drawings, in which:

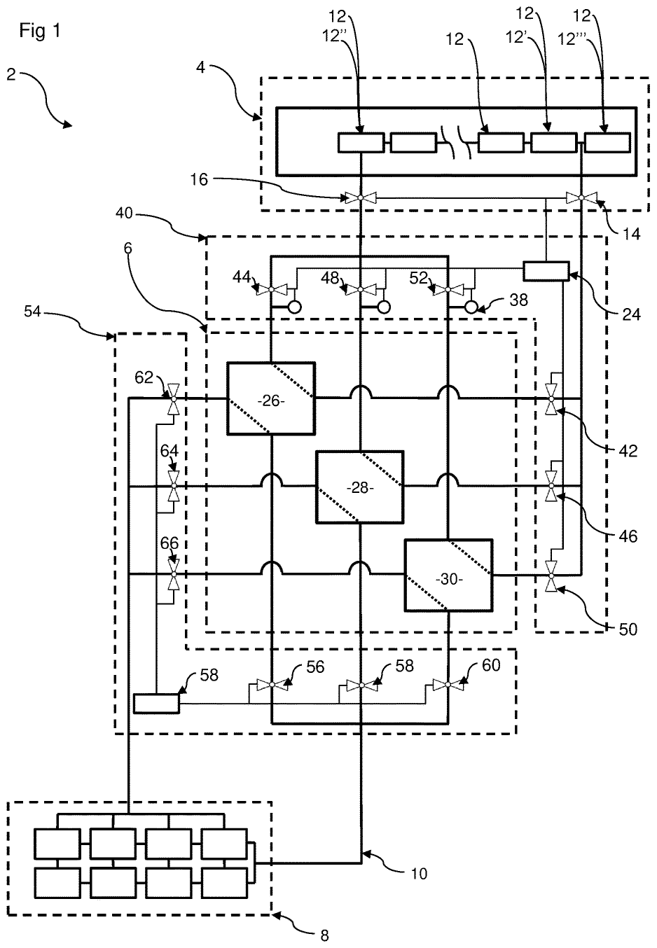

FIG. 1 shows a block diagram schematic representation of a solar-assisted thermal desalination system, in accordance with the first and fifth aspects of the invention including visualisation of a thermal desalination plant with a plurality of processing modules, a solar-assisted heat-exchanger array and at least one solar collector;

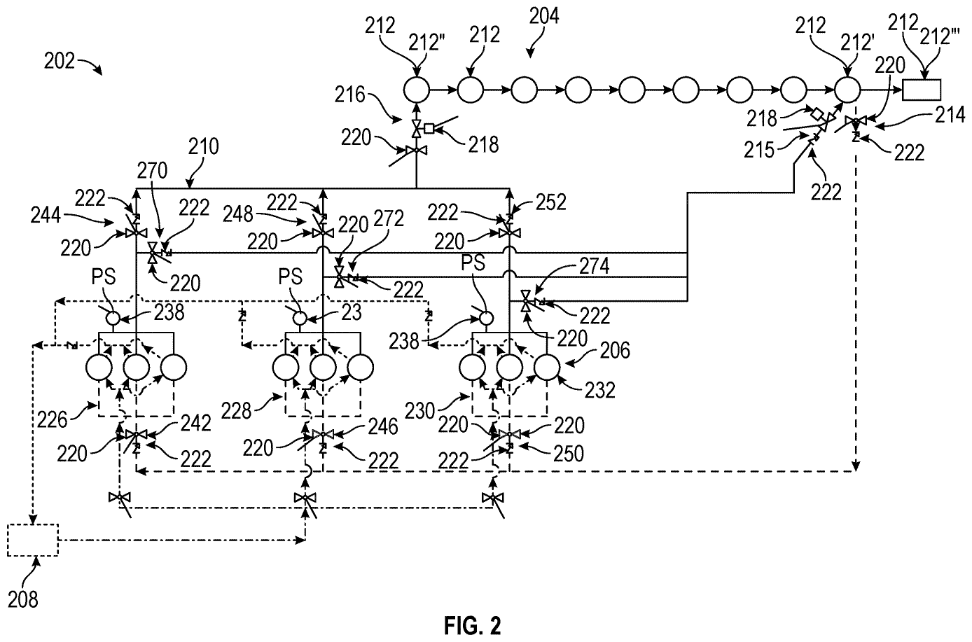

FIG. 2 shows a block diagram schematic representation of another embodiment of the solar-assisted thermal desalination system which includes three heat exchangers within each of a first, second and third heat exchanger modules, and a solar-assisted heat-exchanger array; and

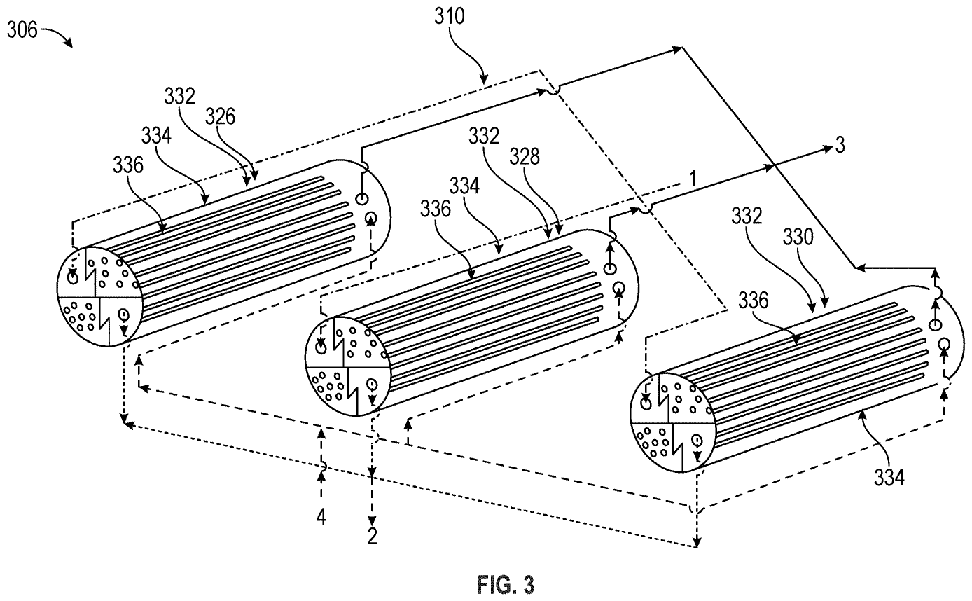

FIG. 3 shows another further embodiment of a solar-assisted heat-exchanger array which includes the first, second and third heat exchanger modules.

Referring firstly to FIG. 1, there is a schematic of a solar-assisted thermal desalination system 2 according to a first aspect of the invention. The system 2 includes a thermal desalination plant 4, a solar-assisted heat-exchanger array 6 and at least one solar collector 8.

The solar-assisted thermal desalination system may be provided in a partly or fully assembled condition. Furthermore, it may also be provided as a kit of parts.

When the solar-assisted thermal desalination system 2 is operating steam from the thermal desalination plant 4 is reconditioned, which is to say that it is superheated, in the solar-assisted heat-exchanger array 6 before being reintroduced to the thermal desalination plant 4. Reconditioning is achieved in this case by supplying heat energy collected by the at least one solar collector 8 and supplying it to the solar-assisted heat-exchanger array 6. Fluid communication within the solar-assisted thermal desalination system 2 is realised by an at least one conduit 10.

Reference is now made to FIG. 2 which shows a preferred embodiment of the solar-assisted thermal desalination system 202. For similar or identical features in FIG. 2 as FIG. 1, the reference numerals from FIG. 1 have been used with 200 added. In this case the thermal desalination plant 204 includes a plurality of processing modules 212 such as those present in a multieffect or multistage distillation thermal desalination plant. A processing module 212 will be understood to include an effect or a stage, a condenser or similar.

In this case, an at least one flow-controllable steam discharge port 214 and equalising inlet port 215 is located at a penultimate processing module 212′ and at least one flow-controllable superheated steam inlet port 216 is located at a first processing module, stage or effect 212″. Where the thermal desalination plant 204 is a multieffect distillation thermal desalination plant, the penultimate processing module 212′ is a final effect prior to a final processing module 212″′ which may be equivalent to a condenser.

In other instances, the at least one flow-controllable steam discharge port may be located between the penultimate and the final processing module. Likewise, the at least one flow-controllable superheated steam inlet port may be located at the first processing module, stage or effect. Additionally, the location of the steam discharge port may be located downstream of a central or substantially central processing module and the superheated steam inlet port may be located upstream of the central or substantially central processing module. However, this may not always be the case, the steam discharge port need only be located downstream of the superheated steam inlet port. For example, the superheated steam inlet port may be located immediately preceding a second processing module and the steam discharge port located between the second and a third processing module.

The at least one flow-controllable steam discharge port 214, as shown in FIG. 2, preferably includes a check valve 222 and a control valve 220. The at least one flow-controllable superheated steam inlet port 216 and the equalising inlet port 215 preferably include a flow control valve 218 and a control valve 220. In this case the control valves 220 may be electric solenoid valves. Although the equalising inlet port 215 is only shown in FIG. 2, it is appreciated that such an equalising inlet port and associated components may be included within the embodiment as shown in FIG. 1.

Control of the flow control and the electric solenoid valves are determined by a determinator element 24, which is shown in FIG. 1 but not shown in FIG. 2. Likewise, the equalising inlet port 215 which includes a flow control valve 218, as per the embodiment shown in FIG. 2, can also communicate with the determinator element. Communication between the determinator element 24 and the electric solenoid valves is preferably via a wired electrical connection.

Control of the at least one flow-controllable steam discharge port and the at least one flow-controllable superheated steam inlet port by the determinator element may also be realised by wireless means. Such wireless means may include Bluetooth (RTM), WiFi (RTM), radio and near field communications (NFC) and the like. Alternatively or additionally, control of steam discharge port and the superheated steam inlet port may be manually controlled.

In other instances, the steam discharge port and the superheated steam inlet port may include or be a globe valve, gate valve, butterfly valve and the like. The superheated steam inlet port and the steam outlet port may also include sensors. Such sensors may include pressure and temperature sensors which in turn can communicate with the determinator element, allowing off-site control and monitoring of the thermal desalination plant and/or automated control.

Although only one steam discharge port 14, 214 and one superheated steam inlet port 16, 216 are shown in FIGS. 1 and 2, multiple steam discharge ports and inlets ports may be included. In this case, multiple solar-assisted heat-exchanger arrays can fluidly communicate with the thermal desalination plant.

In use, and as per the preferred embodiment shown in FIGS. 1 and 2, the thermal desalination plant 4, 204 is a multieffect or multistage distillation thermal desalination plant. A saline fluid feed, which is preferably hypersaline, enters the desalination plant 4, 204 and undergoes successive vaporisation and condensation, as it progresses through the stages or effects 12, 212. Each subsequent stage or effect operating at a lower temperature and pressure than the last, making use of the heat energy from the previous stage or effect. Once the saline fluid feed, which is in the form of steam, leaves the last stage or effect, it can then be sent to the solar-assisted heat-exchanger array 6, 206 via the steam discharge port 14, 214 for reconditioning, which is to say superheating. Once reconditioned, the fluid is then reintroduced into the desalination plant via the superheated steam inlet port 16, 216 for reprocessing, reusing heat energy that would otherwise be lost. Reintroduction of superheated steam back into the thermal desalination plant 4, 204 after reconditioning in the solar-assisted heat-exchanger array 6, 206, defines the end of one cycle and the start of the next.

Referring more specifically to FIG. 2, upon reintroduction of the superheated steam back into the thermal desalination plant 204, the working conditions of the solar-assisted heat-exchanger array 206, at least in part, are equalised with the working conditions of the thermal desalination plant 204 at the point of re-entry, in other words at the relevant stage or effect. As mentioned previously, the working conditions of the steam in terms of temperature and pressure at the point of re-entry are greater than that at the point it leaves the desalination plant 204, in this case, the final stage or effect. In order to begin another cycle, the working conditions of the solar-assisted heat-exchanger array 206, at least in part, are then equalised with the working conditions of the final stage or effect. This equalisation is realised via fluid communication between the solar-assisted heat-exchanger array 206 and the equalising inlet port 215.

Whilst a thermal desalination plant is described, it will be appreciated that similar principles may be applied more generally to other thermal processing plants, for example absorption chillers, such as steam chillers, or a power generation plant.

In the instance of where an absorption chiller plant is used in lieu of the thermal desalination plant, steam is taken from either a first or second chiller effect via a steam discharge port and sent to the solar-assisted heat-exchanger array. Once inside the solar-assisted heat-exchanger array, the steam can be reconditioned by increasing the temperature and pressure to match the working conditions at the point of entry into the first chiller effect. Once reconditioned the steam can be reintroduced into the first chiller effect via a superheated steam inlet port for reprocessing by the absorption chiller plant.

In the instance of where a power generation plant is used in lieu of the thermal desalination plant, steam that has been through a turbine can be redirected to the solar-assisted heat-exchanger array via a steam discharge port for reconditioning. Once reconditioned, the steam can then be reintroduced into the power generation plant for reuse by the turbine, increasing the efficiency of such a power generation plant.

The solar-assisted heat-exchanger array 6, as best shown in FIG. 1, includes a first heat exchanger module 26, a second heat exchanger module 28 and preferably a third heat exchanger module 30. Each said heat exchanger modules are arranged in parallel and are operable in isolation of each other.

There may be more than three heat exchanger modules and associated components, such as four heat exchanger modules.

The embodiment of the solar-assisted thermal desalination system shown in FIG. 2 includes three heat exchangers 232 per each first, second and third heat exchanger module 226, 228, 230. In this instance, the three said heat exchangers 232 are arranged in parallel.

Each heat exchanger, as best shown in FIG. 3, comprises a pressure vessel 334 for receiving the fluid from the thermal desalination plant and a tubular bundle 336 for receiving a working fluid for heating the fluid from the thermal desalination plant. The heating of the working fluid will be better understood from the description below. The embodiment of the solar-assisted heat-exchanger array 306, as shown in FIG. 3, includes only one heat exchanger per first, second and third heat exchanger module 326, 328, 330.

For similar or identical features in FIG. 3 as FIG. 1, the reference numerals from FIG. 1 have been used with 300 added. Although FIGS. 2 and 3 show two embodiments that include one and three heat exchangers 232, 332 per heat exchanger module respectively, each heat exchanger module may include two heat exchangers. Likewise, more than three heat exchangers per module may be included. Additionally, the heat exchangers within a given heat exchanger module may also be arranged in series. The number and configuration of heat exchangers may be adapted for ease of manufacture and transportation whilst also ensuring sufficient throughput. Furthermore, although FIGS. 2 and 3 show the solar-assisted heat-exchanger array 206, 306 to include three heat exchanger modules, more than three may be utilised and arranged in parallel.

The solar-assisted heat-exchanger array 6, 206, 306 is preferably manufactured from a corrosion resistant material. One such corrosion resistant material is stainless steel with a greater than 10% by weight chromium content. Two such grades of stainless steel may include 304 stainless-steel and 316 stainless-steel. Although steel is described, other materials and designs with sufficient corrosion and mechanical properties could be considered, such as metals, for example aluminium, copper, titanium, metal alloys, composite materials, fiberglass or high temperature plastics. Additionally, each of the heat exchangers 232, 332 are thermally insulated from an external environment.

Although described as a tubular bundle, it will be appreciated that other forms and geometries of heat transfer elements may be considered such as finned heat transfer elements.

In use, the solar-assisted heat-exchanger array 6, 206, 306 receives steam from the thermal desalination plant 4, 204 via the steam discharge port 14, 214 and enters the pressure vessel/vessels 334 of the first heat exchanger module 26, 226, 326, this is a state of filling.

Once the or each pressure vessel 334 of the first heat exchanger module 26, 226, 326 is full, it is then sealed and/or isolated from the thermal desalination plant 4, 204. Thermal energy is transferred to the steam which is delivered by the or each tubular bundle 336 of the first heat exchanger module 26, 226, 326. This is a state of reheating or reconditioning.

Once the steam within the or each pressure vessel 334 has reached the correct temperature and pressure for reintroduction back into the thermal desalination plant 4, 204, in other words, once the steam has been superheated, the or each pressure vessel 334 of the first heat exchanger module 326 is then discharged back into the thermal desalination plant 4, 204 via the superheated steam inlet port 16, 216. This is a state of discharge. After discharge, and with specific reference to FIG. 2, the superheated steam inlet port 216 and first outlet valve 244 are then closed. The working conditions of the or each pressure vessel of the first heat exchanger module 226 can then be equalised with that of the final stage or effect by opening of a first equalising outlet port 270. Equalisation of the working conditions of the or each pressure vessel of the first heat exchanger module 226 with the final stage or effect then allows a subsequent state of filling, and the cycle to begin again.

The second and third heat exchanger modules 28, 228, 328, 30, 230, 330 undergo the same process as the first heat exchanger module 26, 226, 326. That is except for that where the first heat exchanger module 26, 226, 326 is in the state of filling, the second heat exchanger 28, 228, 328 is in the state of reheating/reconditioning, while the third 30, 230, 330 is in the state of discharge. Likewise, where the first heat exchanger module 26, 226, 326 is in a state of reheating or reconditioning, the second and third heat exchanger modules 28, 228, 328, 30, 230, 330 are in the state of discharge and filling respectively, and so on and so forth. In short, the first, second and third heat exchanger modules 26, 226, 326, 28, 228, 328, 30, 230, 330 are each in the different state of filling, reconditioning or reheating and discharge, at any one time. The state of each heat exchanger module is determined by a reheating schedule. This allows a continuous reintroduction of superheated back into the thermal desalination plant.

Like that of the first heat exchanger module 226, after the respective discharge of the second and third heat exchanger modules 228, 230, the working conditions of the respective the or each pressure vessels are equalised with the final stage or effect. This is achieved by the opening of a second equalising outlet port 272 and a third equalising outlet port 274 associated with the second and third heat exchanger modules 228, 230, respectively.

In the state of reheating/reconditioning as explained above, steam within the pressure vessel/vessels 334 is heated and pressurised so as to superheat the steam.

If more than three heat exchanger modules were included, a fourth state may be considered, wherein one of the heat exchanger modules is in a storage state. This can help provide more uniform or reliable reintroduction of steam back into a thermal desalination plant.

The solar-assisted thermal desalination system 2 also includes a flow controller 40 as best shown in FIG. 1. In this case, the flow controller 40 includes a first inlet valve 42 and a first outlet valve 44 associated with the first heat exchanger module 26; a second inlet valve 46 and a second outlet 48 valve associated with the second heat exchanger module 28; and a third inlet valve 50 and a third outlet valve 52 associated with the third heat exchanger module 30. Each inlet valve is located upstream of the corresponding heat exchanger module 26, 28, 30 and each outlet valve is located downstream.

Included in the flow controller 40 and located upstream of the first, second and third outlet valves 44, 48, 52, as shown in FIG. 1, are three sensor modules or sensor elements 38. Each said sensor module or element 38 includes a pressure and/or a temperature sensor.

The flow controller 40 also includes the determinator element 24 which is electrically connected to the first, second and third said inlet and outlet valves 42, 44, 46, 48, 50, 52 and each of the sensor modules 38. In this case the determinator element 24 includes a PLC module and a proportional integral derivative (PID) controller.

The flow controller, as per the embodiment of the solar-assisted thermal desalination system 202 as shown in FIG. 2, also includes the first, second and third inlet and outlet valves 242, 244, 246, 248, 250, 252 in this case each said valves includes both a check valve 222 and a control valve 220.

In the instance where more than three heat exchanger modules are utilised, the flow controller may also include corresponding inlet and outlet valves for each subsequent heat exchanger modules. Likewise, a corresponding sensor module may also be included and associated with each subsequent heat exchanger modules. Inlet valves, outlet valves and sensor modules may also be associated with each heat exchanger.

The sensor modules may include or be a flow sensor such as pitot tube, and sensors that can determine the chemical composition of the steam, such as a sampling probe. Such sensor modules may also be located immediately downstream of the first, second, third and subsequent inlet valves.

Although communication of the valves and sensor modules 38, 238 with the determinator element 24 is realised within the embodiments as shown in FIGS. 1 and 2 by wired electrical communication, this may also be realised by wireless means. Such wireless means may include Bluetooth (RTM), WiFi (RTM), radio and near field communications (NFC) and the like.

In use, independent control of the first, second and third heat exchanger modules 26, 28, 30 can be realised by the control of the first, second and third inlet and outlet valves 42, 44, 46, 48, 50, 52. Where the heat exchanger module is in the state of filling, the inlet valve is open whilst the outlet valve is closed. In the reheating/reconditioning state, both the inlet and outlet valves are closed. In the state of discharge, the inlet valve is closed whilst the outlet valve is open. Control of the inlet and outlet valves can be determined by the PLC modules of the determinator element and according to the reheating schedule. Control of the inlet and outlet valves may also be further aided by the PID controller of the determinator element that communicates with the sensor modules.

The at least one solar collector 8, as best shown in FIG. 1, is an array of solar collectors. The or each said solar collector 8 may be a flat plate solar collector, linear fresnel reflector, parabolic dish or parabolic trough solar collector that heats the working fluid. The said working fluid in this instance is salty water. In other instances, the working fluid may be oil, for example.

Alternatively, the at least one solar collector may be or include solar cells. In this instance, the solar cells electrically communicate with the first, second and third heat exchanger modules. In this case, the tubular bundles may be electric heating elements.

In use thermal energy is supplied to the solar-assisted heat-exchanger array 6 via the working fluid. The working fluid is heated primarily by the electromagnetic solar energy collected by the at least one solar collector 8. However, thermal energy transferred to the working fluid may also be supplied by convection and/or conduction at or by the at least one solar collector 8. The heated working fluid then flows through the tubular bundles 336 and heats the steam within the pressure vessel 334 of the heat exchangers 232, 332. The working fluid then leaves the solar-assisted heat-exchanger array 6, 206, 306 and returns to be reheated by the at least one solar collector 8, 208.

In the case where the working fluid is saline fluid, the heated working fluid may be directed, at least in part, to the thermal desalination plant for it to be vaporised before entry into the start of the thermal desalination plant.

The flow and flow rate of the working fluid supplied to the solar-assisted heat-exchanger array 6 may be controlled by a working-fluid flow controller 54, as best shown in FIG. 1. In this case the working-fluid flow controller 54 includes a first, second and third working-fluid input valves 56, 58, 60 located upstream of the first, second and third heat exchanger modules 26, 28, 30, respectively. Likewise, a first, second and third working-fluid output valves 62, 64, 66 may also be included downstream of the first, second and third heat exchanger modules 26, 28, 30, respectively. The valves are electrically connected to a working-fluid determinator element 68. The working-fluid determinator 68 element includes a PLC module for controlling the valves.

In other instances, the working fluid determinator element may be in communication with the determinator element of the flow controller. Alternatively, the working fluid determinator element and the determinator element maybe one and the same. In such instances, the control of the working-fluid input and output valves may be further aided by the sensor modules of the flow controller. Although communication of the valves with the working-fluid determinator 68 element is realised within the embodiment shown in FIG. 1 by electrical communication, this may also be realised by wireless means. For example, Bluetooth (RTM), WiFi (RTM), radio and near field communications (NFC) and the like.

Fluid communication is facilitated by the at least one conduit 10, 210, 310. Such a conduit 10, 210, 310 may be manufactured from a corrosion resistant material with mechanical properties to withstand the required pressure and temperature. Such pressures may range from 0.1 to 2 bar or more and temperatures from 30 to 140 °C or more. Such a material includes stainless-steel with an at least 10 % weight chromium content. Additionally, the internal surfaces of such stainless-steel conduits may be manufactured to have a smooth surface finish to help avoid deposit build-ups. The conduit may also be constructed using carbon steel with an internal corrosion resistant coating, high temperature plastic, fiberglass or carbon fiber composite.

In some embodiments the conduits may include pumps to create the required pressure gradients, or to overcome pressure gradients, to allow fluid to flow in the desired direction. Such pumps may be vacuum pumps. Additionally, inclusion of such pumps may negate the step, and associated apparatus, of equalising the working conditions of the heat exchanger modules with the final stage or effect after the or each heat exchanger module has undergone a state of discharge.

Such metallic conduits may also include secondary corrosion protection. Such corrosion protection may be or include cathodic protection.

Check valves may be any type of check valve, including swing, tilting disk, wafer, disk, piston, ball, duo, or non-slam check valves. Control valves may be or include ball, globe, gate and butterfly valves. The control valves may also include electrical and/or pneumatic actuators.

A solar-assisted heat-exchanger array comprising the at least first, second and third heat exchanger modules, the flow controller including the determinator element and the at least one solar collector, may be provided and retrofitted to an existing thermal desalination plant or thermal processing plant.

It is therefore possible to provide a solar-assisted thermal desalination system. This allows recirculation of steam to be superheated so as to allow reintroduction into a thermal desalination plant for retreatment, thereby increasing the efficiency of such a thermal desalination plant by utilising the latent heat of the steam that would otherwise be lost.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1.-19. (canceled).

20. A method of improving thermal processing efficiency of a thermal desalination plant, using a solar-assisted thermal desalination system which includes a thermal desalination plant having at least one flow-controllable superheated steam inlet port, at least one flow-controllable steam discharge port, and a plurality of processing modules arranged in series for sequential heat treatment of the said steam, the steam discharge port being located downstream of a central processing module and the superheated steam inlet port being located upstream of the central processing module; a solar-assisted heat-exchanger array having at least first, second, and third heat exchanger modules which are configured to be operated in isolation of each other; a flow controller configured to control steam flow from the steam discharge port to each of the first, second, and third heat exchanger modules, the flow controller including at least one of a controller and a programmable logic control module configured to control which of the first, second, and third heat exchanger modules receives steam from the steam discharge port based on a reheating schedule whereby a continuous supply of superheated steam is configured to be outputted to the superheated steam inlet port for reprocessing; and at least one solar collector in communication with the first, second, and third heat exchanger modules to supply solar heat energy thereto, the method comprising the steps of:
a] inputting a saline fluid feed into the thermal desalination plant, the saline fluid feed progressing through the plurality of processing modules and undergoing successive vaporisation and condensation, each subsequent processing module operating at a lower temperature and pressure than the last;
b] outputting excess steam of the saline feed fluid from the steam discharge port of the thermal desalination plant to a solar-assisted heat-exchanger array; and
c] controlling the solar-assisted heat-exchanger array so that at least the first, second, and third heat-exchanger modules:
i] are filled with said excess steam;
ii] the said excess steam is superheated at least in part by solar energy; and
iii] the excess steam which has been superheated is discharged to a superheated steam inlet port of the thermal desalination plant for reprocessing;
wherein, the reheating schedule is configured such that the first heat-exchanger module is controlled to undertake sub-steps i], ii], iii], while the second heat-exchanger module is controlled to undertake sub-steps ii], iii], i], while the third heat-exchanger module is controlled to undertake sub-steps iii], i], ii].

21. The method of improving thermal processing efficiency of a thermal desalination system as claimed in claim 20, wherein a step c] further comprises a sub-step iv] prior to sub-step iii] of partially discharging at least one heat exchanger module so as to match the working conditions including temperature and pressure of the thermal processing plant at the point of input back into said thermal processing plant.

22. The method as claimed in claim 20, wherein the solar-assisted thermal desalination system further comprises a fourth heat exchanger module, the at least one of the controller and the programmable logic control module being configured to determine which of the first, second, third, and fourth heat exchanger modules receive steam from the steam discharge port based on the reheating schedule, and the solar collector being in communication with the fourth heat exchanger module.

23. The method as claimed in claim 20, wherein the flow controller includes:
a first inlet valve and a first outlet valve associated with the first heat exchanger module;
a second inlet valve and a second outlet valve associated with the second heat exchanger module; and
a third inlet valve and a third outlet valve associated with the third heat exchanger module.

24. The method as claimed in claim 20, wherein the flow controller includes at least one sensor for the heat exchanger modules.

25. The method as claimed in claim 24, wherein said at least one sensor is configured to determine at least one of pressure and temperature.

26. The method as claimed in claim 24, wherein the controller is in communication with the at least one sensor configured to identify when the steam has reached a pre-determined condition so as to be configured to be reintroduced into the thermal desalination plant.

27. The method as claimed in claim 20, wherein each of the heat exchanger modules includes at least three heat exchangers.

28. The method as claimed in claim 20, wherein the at least one solar collector is in fluid communication with the heat exchanger modules.

29. The method as claimed in claim 20, wherein the solar-assisted thermal desalination system further includes a working-fluid flow controller configured to control a working fluid from the at least one solar collector to the first, second, and third heat exchanger modules, the working-fluid flow controller having a working-fluid programmable logic control module configured to determine flow rate to each of the first, second and third heat exchanger modules.

30. The method as claimed in claim 29, wherein at least one of the controller and the programmable logic control module and the working-fluid programmable logic control module are in communication with each other.

31. The method as claimed in claim 29, wherein the working-fluid flow controller includes:
a first working-fluid input valve associated with the first heat exchanger module;
a second working-fluid input valve associated with the second heat exchanger module;
a third working-fluid input valve associated with the third heat exchanger module;
wherein each of the working-fluid input valves are controlled by the working-fluid programmable logic control module.
